(19) United States
(12) Patent Application Publication
(10) Pub. No.: US 2025/0005976 A1
(43) Pub. Date: Jan. 2, 2025

(54) PREDICTIVE MAINTENANCE SYSTEM AND METHOD FOR A WORK MACHINE HAVING A TRACKED UNDERCARRIAGE

(71) Applicant: Deere & Company, Moline, IL (US)

(72) Inventors: Yuvraj Patil, Pune (IN); Snehal Kumbhoje, Pune (IN); Mayur D. Jagtap, Pune (IN)

(21) Appl. No.: 18/342,323

(22) Filed: Jun. 27, 2023

(51) Int. Cl. G07C 5/08; G05B 13/02; G05B 13/04; G07C 5/10

(52) U.S. Cl. CPC G07C 5/0825; G05B 13/0265; G05B 13/048; G07C 5/10

(57) ABSTRACT

A predictive maintenance system and method for use with a work machine having a tracked undercarriage is disclosed. The system comprises a tracked undercarriage, a power source, and a controller. The controller comprises one or more processors and a memory having a predictive maintenance algorithm stored thereon. The algorithm performs the following steps. It receives a historical operational data from sensors associated with operation of the tracked undercarriage and receives historical inspection data associated with the amount of wear. Next it extracts features from the historical operational data that includes an operation parameter associated with wear of the tracked undercarriage. It then trains a predictive model using the features, the historical inspection data, and a labeled dataset regarding an actual maintenance need or health information of the tracked undercarriage. The algorithm applies the model to generate a prediction of the maintenance needs or health information to perform a suggested action.

### TECHNICAL FIELD

The disclosure generally relates to a predictive maintenance system for a tracked undercarriage of a work machine.

### BACKGROUND

Work machines with a tracked undercarriage are used to perform various tasks in industry with various ground and load conditions. In the construction and forestry industries, work machine tracked undercarriages may include dozers, excavators, loaders, compact track loaders, feller bunchers, harvesters, mulchers, for example. The tracked undercarriage provides a high tractive force and stability to assist in traversing across various surfaces. However, because of the variability in surface conditions, the maintenance frequency to ensure proper operation may differ. Proper maintenance of the tracked undercarriage minimizes the rate of component wear and prolongs undercarriage lifespan. Component wear is typically non-linear wherein wear may accelerate at a critical point. For example, the function of tracked undercarriages may be aggravated by worn track pins and bushings or debris accumulation, and thereby increase friction and the energy required to perform. Maintenance routines typically require an operator to periodically inspect the wear of a tracked-chain undercarriage. Furthermore, an operator may rely solely on rigid time intervals for manual inspections to estimate a remaining useful life or a health of a component. In one exemplary application, a silt like ground surface may require component replacement every 4000 operational hours, whereas coral sand may require component change every 1500 hours. This method can cause premature replacement, or alternatively require excess power consumption if a tracked undercarriage is beyond its optimal performance range and thereby reducing performance. A tracked undercarriage is the costliest portion of maintenance requiring as much as 50% of total maintenance costs. Therein lies an opportunity to optimize a maintenance schedule to maximize use of tracked undercarriage components on a tracked undercarriage

### SUMMARY

A predictive maintenance system and method for use with a work machine having a tracked undercarriage is disclosed. The system comprises a tracked undercarriage, a power source, and a controller. The controller comprises one or more processors and a memory having a predictive maintenance algorithm stored thereon. The algorithm performs the following steps. It receives a historical operational data from sensors associated with operation of the tracked undercarriage and receives historical inspection data associated with the amount of wear. Next it extracts features from the historical operational data that includes an operation parameter associated with wear of the tracked undercarriage. It then trains a predictive model using the features, the historical inspection data, and a labeled dataset regarding an actual maintenance need or health information of the tracked undercarriage. The algorithm applies the model to generate a prediction of the maintenance needs or health information of one or more components of the tracked undercarriage. The algorithm then outputs the prediction of health information to operator interface. The feature from the historical operational data comprises one or more of a forward distance traveled by each a left track and a right track of the tracked undercarriage, a reverse distance travelled, a duration of operation by the tracked undercarriage, and a rotation torque associated with the track of the tracked undercarriage.

The historical inspection data comprises one or more of a link height, a bushing wear, a grouser wear, and a track extension. The historical inspection data may further be derived from the last known inspection data. Extraction of features from the historical operational data may initiate after a threshold of operation duration or a travelled distance of the tracked undercarriage occurs. The historical operational data may further be derived from an aggregate of historical operational data from two or more work machines with at least a similar machine type, an operator, an operator, a geographic location, a soil type, a dealer, and a work machine operation type. In another aspect, features from the historical operation data comprises of a power source utilization for sprocket movement an implement movement.

The predictive model may be periodically applied and update the prediction and health information outputs to one of a plurality of communicatively coupled work machine, a central operating center, and dealers. The feature from the historical operational data comprises a power source utilization duration with a low load condition, a medium load condition, and a high load condition.

The method for performing a predictive maintenance of a tracked undercarriage on a work machine is disclosed. In a first step, the method includes receiving a historical operational data from sensors associated with the operation of the tracked undercarriage. In a next step, the method includes receiving a historical inspection data associated with an amount of wear of the tracked undercarriage. The method then involves extracting one or more features from the historical operational data wherein the one or more features includes at least one operation parameter associated with wear of the tracked undercarriage. Next, training a predictive model using the one or more features, the historical inspection data, and a labeled dataset regarding an actual maintenance need or health information of the tracked undercarriage occurs. The method then includes applying the predictive model to the one or more features to generate a prediction of the maintenance needs or health information of one or more components of the tracked undercarriage. Finally, then method involves outputting the prediction or health information to an operator interface.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic of a work machine with tracked undercarriage:

FIG. 2A is a detailed schematic of a portion of a track in the exemplary embodiment of FIG. 1:

FIG. 2B is a zoomed in schematic of a portion of a track in the exemplary embodiment of FIG. 2A:

FIG. 3 is a schematic of portions of the tracked undercarriage shown in the exemplary embodiment of FIG. 1

FIG. 4 is a schematic of an exemplary predictive maintenance control system, that may be implemented in associated with the work machine in FIG. 1:

FIG. 5 is a simplified flowchart of the predictive maintenance control system for according to the disclosure.

FIG. 6 is a flowchart setting forth an example of a method for a prediction or acquiring of health information of a tracked undercarriage component, which may be carried out by a controller included in the predictive maintenance control system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B: B and C: A and C: or A, B, and C).

As used herein, “controller” is intended to be used consistent with how the term is used by a person of skill in the art, and refers to a computing component with processing, memory, and communication capabilities, which is utilized to execute instructions (i.e., stored on the memory or received via the communication capabilities) to control or communicate with one or more other components. In certain embodiments, the controller may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller may be in communication with other components on the work machine, such as hydraulic components, electrical components, and operator inputs within an operator station of an associated work machine. The controller may be electrically connected to these other components by a wiring harness such that messages, commands, and electrical power may be transmitted between the controller and the other components. Although the controller is referenced in the singular, in alternative embodiments the configuration and functionality described herein can be split across multiple devices using techniques known to a person of ordinary skill in the art. The controller 84 includes the tangible, non-transitory memory 85 on which are recorded computer-executable instructions, including a predictive maintenance for a track chain undercarriage algorithm. The processor of the controller is configured for executing the predictive maintenance algorithm.

The controller may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 85 may include any non-transitory/tangible medium which participates in providing data or computer-readable instructions. The memory 85 may be non-volatile or volatile. Non-volatile media may include, for example, optical or magnetic disks and other persistent memory. Example volatile media may include dynamic random-access memory (DRAM), which may constitute a main memory. Other examples of embodiments for memory 85 include a floppy, flexible disk, or hard disk, magnetic tape or other magnetic medium, a CD-ROM, DVD, and/or any other optical medium, as well as other possible memory devices such as flash memory.

As such, a method 600 may be embodied as a program or algorithm operable on a controller. It should be appreciated that the controller may include any device capable of analyzing data from various sensors, comparing data, making decisions, and executing the required tasks.

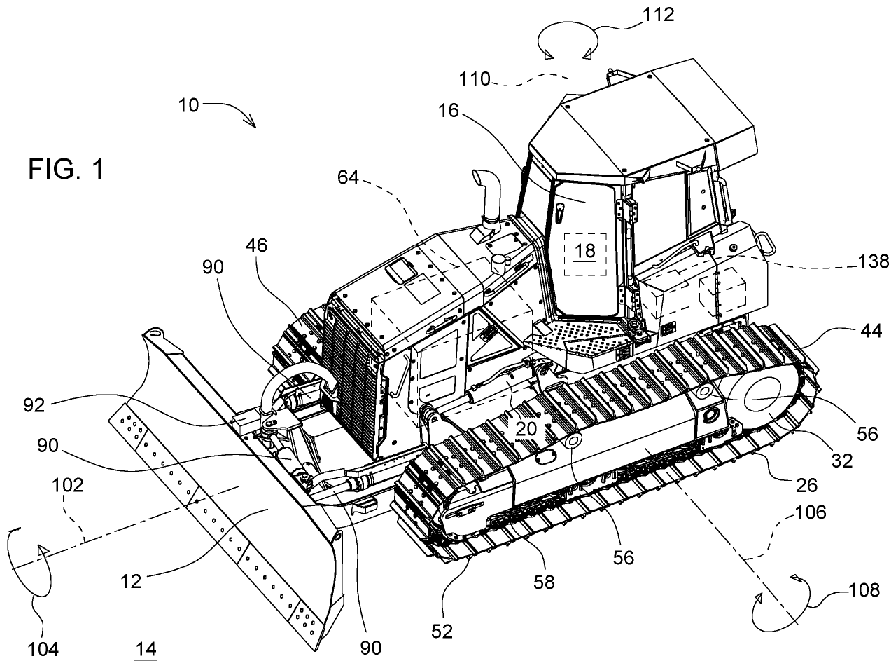

FIG. 1 is a perspective view of work machine 10. Work machine 10 is illustrated as a crawler dozer. Work machine 10, with an implement 12 shown here as a blade, may be operated to engage the ground 14 and cut and move material to achieve simple or complex features. As used herein, directions with regard to work machine 10 may be referred to from the perspective of an operator seated within an operator cab 16: the left of work machine 10 is to the left of such an operator, the right of work machine is to the right of such an operator, the front or fore of work machine is the direction such an operator faces, the rear or aft of work machine 10 is behind such an operator, the top of work machine is above such an operator, and the bottom of work machine is below such an operator. Direction for an implement 12 coupled to a work machine 10 may also be referred to with regard to longitude 102 or the longitudinal direction, latitude 106 or the lateral direction, and vertical 110 or the vertical direction. Rotation for work machine 10 may be referred to as roll 104 or the roll direction, pitch 108 or the pitch direction, and yaw 112 or the yaw direction or heading.

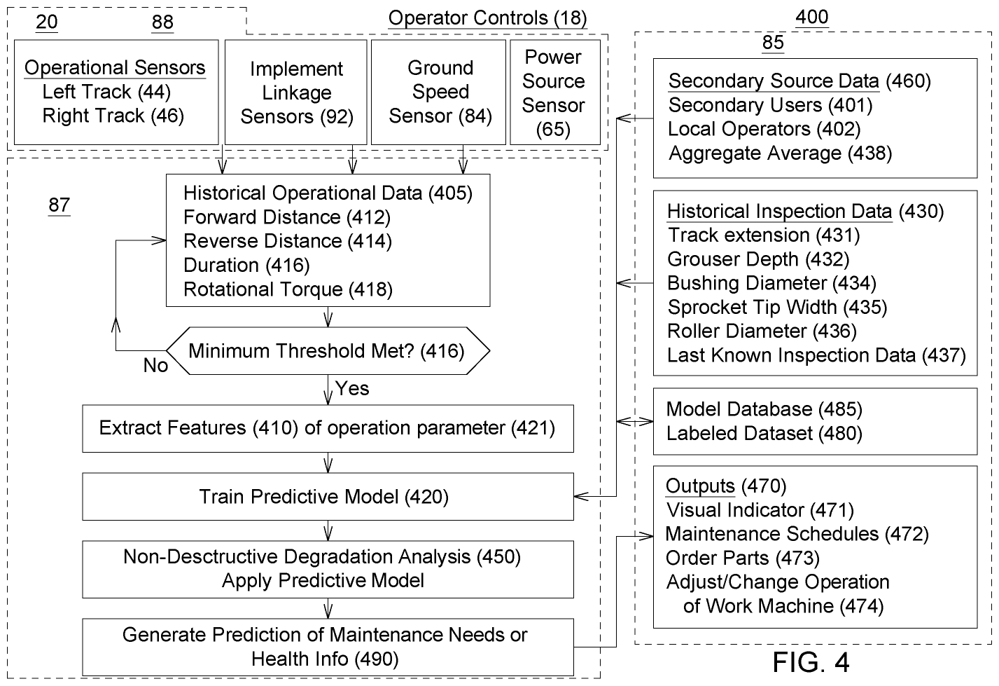

Referring to FIGS. 1, 2A, 2B, and 3, a tracked undercarriage 20 of a work machine 10 using a predictive maintenance system 400 (shown in FIG. 4) is schematically presented in accordance with an exemplary embodiment of the present disclosure. The exemplary tracked undercarriage 20 can be integrated into or support any type of work machine 10, including but not limited to, tracked loaders, dozers, excavators, cranes, and other work machines with tracked undercarriages as utilized within the construction, agricultural, mining, and forestry industries.

Undercarriage 20 includes left track 44 and right track 46, which engage the ground and provide tractive force for work machine 10. Left track 44 and right track 46 are comprised of track shoes 40 with grousers 52 that sink into the ground to increase traction, and interconnecting components that allow the tracks to rotate about the front idler wheel 30, carrier rollers 56, rear sprockets 32 and roller wheels 58. The interconnecting components include the track links 34, pins 36a, and bushings 36b, to name a few. Idler wheel 30, carrier rollers 56, rear sprockets 32 and roller wheels 58 are all pivotally connected to the remainder of work machine 10 and rotationally coupled to their respective tracks so as to rotate with those tracks.

Idler wheels 30 are positioned at the longitudinal front of left track 44 and right track 46 and provide a rotating surface for the track chain 26 to rotate about and a support point to transfer force between work machine 10 and the ground 14. Left track 44 and right track 46 rotate about idler wheels 30 as they transition between their vertically lower and vertically upper portions parallel to the ground, so approximately half of the outer diameter of each of front idler wheels 30 is engaged with left track 44 or right track 46. The pins 36a and bushings 36b engage with the recesses in idler wheel so as to transfer force. This engagement also results in the vertical height of left track 44 and right track 46 being only slightly larger than the outer diameter of each of the idlers wheels 30 at the longitudinal front of left track 44 and right track 46. Frontmost engaging point of left track 44 and right track 46 can be approximated as the point on each track vertically below the center of front idler wheels 30, which is the frontmost point of left track 44 and right track 46 which engages the ground. When work machine 10 encounters a ground feature when traveling in a forward direction, left track 44 and right track 46 may first encounter it at frontmost engaging point. In this embodiment, front idler wheels 30 are not powered and thus are freely driven by left track 44 and right track 46. In alternative embodiments, front idler wheels 30 may be powered, such as by an electric or hydrostatic motor, or may have an included braking mechanism configured to resist rotation and thereby slow left track 44 and right track 46. If a work machine operated on a sloped surface in a lateral direction 106, the load distribution and torque power required for movement may be skewed towards the track and its components sitting at a lower elevation.

Carrier rollers 56 and roller wheels 58 (may hereinafter be collectively referred to as track rollers) are longitudinally positioned between front idler wheels 30 and rear sprocket 32 along the left and right sides of work machine 10. The carrier rollers 56 are longitudinally positioned between front idlers 120 and rear sprocket 32 along the left and right sides of work machine 10 above the roller wheels 58. This configuration may allow the carrier rollers 56 to support left track 44 and right track 46 for the longitudinal span between idler wheel 30 and rear sprocket 32 and prevent downward deflection of the upper portion of track chain 26 between idler wheel 30 and rear sprocket 32.

Rear sprockets 32 may be positioned at the longitudinal rear of left track 44 and right track 46 and, similar to front idler wheels 30, provide a rotating surface for the tracks to rotate about and a support point to transfer force between work machine 10 and the ground. Left track 44 and right track 46 rotate about rear sprockets 32 as they transition between their vertically lower and vertically upper portions parallel to the ground, so approximately half of the outer diameter of each of rear sprockets 32 is engaged with left track 44 or right track 46. This engagement may be through a sprocket 32 and pin 36a arrangement, where pins included in left track 44 and right track 46 are engaged by recesses in rear sprockets 32 so as to transfer force. This engagement also results in the vertical height of left track 44 and right track 46 being only slightly larger than the outer diameter of each of rear sprockets 124 at the longitudinal back or rear of left track 44 and right track 46.

In this particular embodiment, each of rear sprockets 32 may be powered by a rotationally coupled hydrostatic motor (78, 80) so as drive left track 44 and right track 46 and thereby control propulsion and traction for work machine 10. Each of the left and right hydraulic motors (78, 80) may receive pressurized hydraulic fluid from a left or right hydrostatic pump (72, 74) whose direction of flow and displacement controls the direction of rotation and speed of rotation for the left hydrostatic motors 78 and the right hydrostatic motor 80. Each hydrostatic pump (72, 74) may be driven by a power source 64 of work machine 10, and responds to issuing commands which may be received by controller 84 (e.g. an operator control or automated source from memory 85) and communicated to each the left and right hydrostatic pumps (72, 74). In alternative embodiments, each of rear sprockets 32 may be driven by an electric motor rotationally coupled to final drives (68, 70) with battery power source. The power source 64 in this particular embodiment is shown with an engine (e.g. diesel engine), the hydrostatic transmission 66, a left final drive 68, and a right final drive 70. However, the predictive maintenance system 400, described in detail below, is applicable to other configurations of power sources 64 coupled to the final drives (68, 70) to assess the health of a tracked undercarriage component 50. The features 410 from the historical operational data 405 may be derived from each a parameter 421 associated with the final drive (68, 70) of each the left track 44 and the right track 46 of the tracked undercarriage 20, driven by a power source 64.

During operation of the work machine 10, the power source 64 drives rotation of each the left and right tracks (44, 46) through motors (78, 80) and the final drives (68, 70). In one example, the rotating mechanical output of the engine drives left and right hydrostatic pumps (72, 74). The hydrostatic pumps (72, 74) are fluidly interconnected through other fluid-conducting components of the hydrostatic transmission, such as filters, reservoirs, heat exchangers, and the like. The hydrostatic pumps (72, 74) are further fluidly coupled to and drive the hydrostatic motors (78, 80) contained within the hydrostatic transmission 66. The mechanical output shafts of the hydrostatic motors (78, 80), then drive rotation of the sprockets 32 engaging the track chain 26 through the final drives (68, 70). At least one power sensor 65, such as an engine speed sensor associated with an engine, or a dynamometer for an electric power work machine observes an operational speed, such as rotational speed of an output shaft associated with the engine and generates sensor signals based on this observation. The power sensor signals 67 are communicated to controller 84. If hydrostatic motors (78, 80) are used, one or more hydrostatic drive motor sensors (79, 81) monitor a speed of a respective speed of each hydrostatic motor (78, 80) and generates sensor signals 82 or sensor data based thereon, which may be received and communicated by controller 84 to determine the speed of each hydrostatic motor (78, 80).

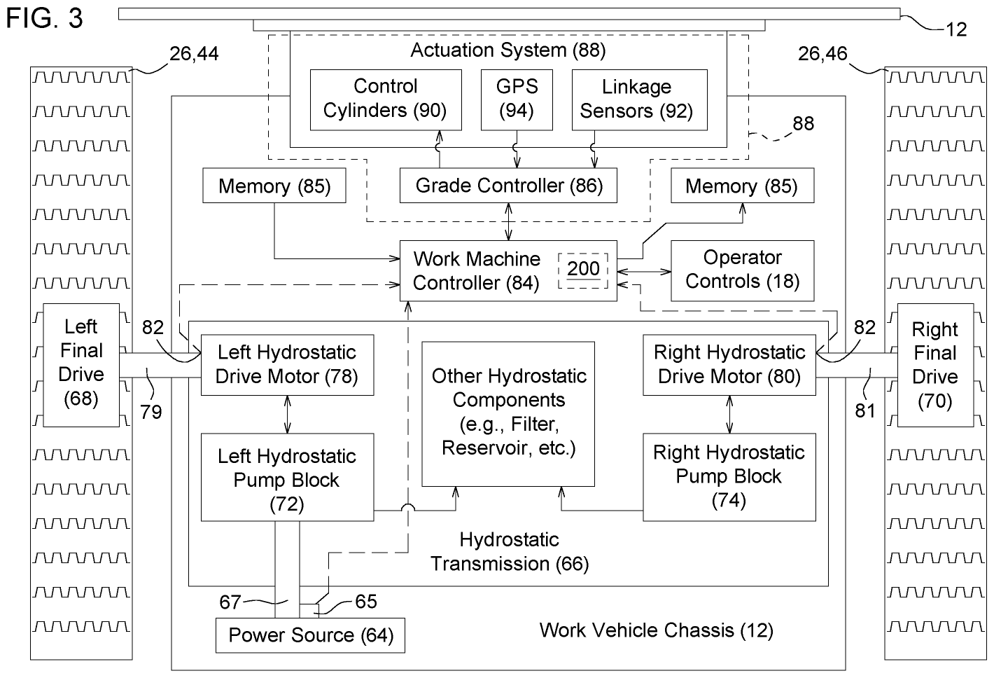

As shown in FIG. 3, the work machine 10 may further include an implement actuation system 88. The implement actuation system 88 for this embodiment contains a number of control cylinders 90 and linkage sensors 92. The linkage sensors 92 may observe a condition associated with the implement 12, for example, a position of the implement, such as a pitch and a height of the implement 12 relative to gravity, and generate sensor signals to output data for the controller 84. The linkage sensors 92 may include various different combinations force sensors (e.g. load cells) for measuring the forces applied through the implement 12 and the linkage, positional sensors for measuring the stroke of the control linkage, wear sensors, and/or various other sensors for monitoring the operational parameters of the implement actuation system 88 (e.g. cameras, depth sensors, IMUs) that observe a position of the implement relative to the other sensors signals to identify the operational state of the work machine 10 relative to a power source 64 utilization duration. Other operational data 410 sources may include position data and ground speed data from a GPS (global positioning system), or a throttle control sensor, for example.

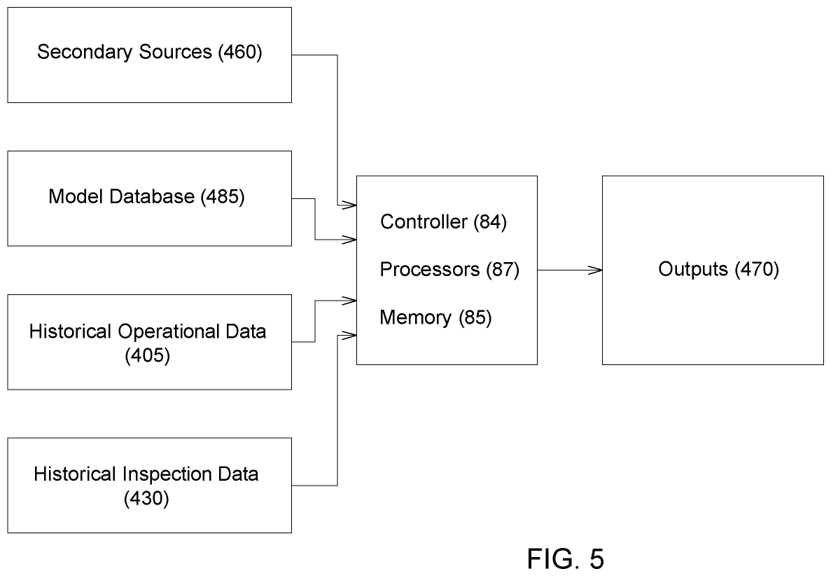

Now turning to FIGS. 4 and 5, schematics of an exemplary flow of inputs and outputs of the predictive maintenance system 400. The predictive maintenance system 400 comprises the tracked undercarriage 20, a power source 64 operatively coupled to the tracked undercarriage 20, and a controller 84 operatively coupled to the power source 64. The controller 84 comprises one or more processors 87 and a memory 85 having a predictive maintenance algorithm 89 stored thereon. The one or more processors 87 is operable to execute the predictive maintenance algorithm 89 to receive a historical operational data 405 from sensors, as described above from various sensors associated with the operation of the tracked undercarriage 20 and the implement 12.

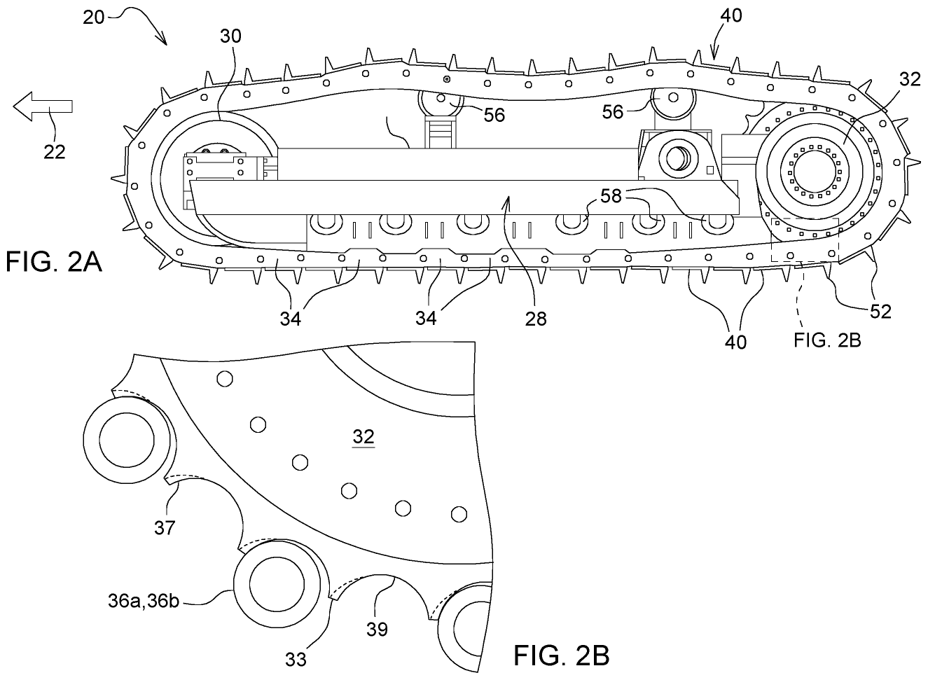

The one or more processors 87 extract one or more features 410 from the historical operational data 405, the one or more features including at least one operation parameter 421 associated with wear of the tracked undercarriage 20. Features 410 from the historical operational data 405 include, but is not limited to, data associated with one or more of a forward distance 412 traveled by a track (44, 46) of the tracked undercarriage 20; a reverse 414 distance traveled by the track (44, 46) of the tracked undercarriage 20; a duration of an operation 416 by the tracked undercarriage 20; and a rotational torque (418a, 418b) (or rimpull) associated with each respective track (44, 46) of the tracked undercarriage 20. An operator's technique, as communicated through operator controls 18 of use of the work machine 10 may also have an impact on the health of a tracked undercarriage component 50. In one exemplary operation, sharp turns when navigating the work machine may reduce the life expectancy of a tracked undercarriage component 50. As known by a person of skill in the art, turning a tracked work machine requires a first track to rotate in one direction while the other track rotates in the opposite direction. Reverse operations of tracks (44, 46) generally impact wear differently from forward operations. For example, as shown in FIG. 2B, a sprockets teeth 33 may wear (shown in dotted lines 37) when moving in a forward direction because of the direction of contact, and area of force. Counter rotations, spinning, duration of operation on a slope, ground conditions, and contact with curb lines may further impact the health of each respective track. Additionally, characteristics of a track chain 26 may differ based on a chosen track chain. Characteristics of track chains 26 may include the number of grousers 52 per shoe 40, a width of the track shoes 40, track tension, material composition or design of a track chain 26, to name a few, thereby by possibly impacting a tracked undercarriage component's longevity or maintenance schedule.

The features 410 from the historical operational data 405 may further comprise associating the data with a power source utilization duration as bucketed under definitions of low load conditions, medium load conditions, and high load conditions, as derived from the operational parameters 421 associated with rimpull, a right final drive 70, a left final drive 68, and load on an implement 12. Another example of bucketing load conditions may include identifying a difference between the commanded speed (e.g. operator controls 18) or determined speed of at least one of the tracks (44, 46), and the ground speed (derived from a ground speed sensor 84 or a location tracking sensor) wherein the speed differential associates with a load condition. The features 410 from the historical operational data 405 may further differentiate power source 64 utilization of the final drives (68, 70) rotating sprockets (32), as compared to implement movement from linkage sensors 92. The extraction of features 410 from the historical operational data 405 in the predictive maintenance system 400 advantageously applies to alternative power sources, including but not limited to battery electric, solar, hydrogen power, etc, wherein the predictive maintenance system 400 may utilize similar algorithms to train a predictive model 420 for a prediction or health assessment of a tracked undercarriage component 50 of a work machine 10.

The one or more processors 87 further receive a historical inspection data 430 associated with the wear of the tracked undercarriage 20. Exemplary inspection data 430 may comprise one or more of measuring the track extension 431, grouser depth 432, and idler wheel diameter 433, bushing diameter 434, sprocket tip widths 435, and a roller (56, 58) diameter 436, to name a few. With respect to grouser depth 432, the area of the component with the greatest exposure of wear includes the tip of the grouser 52 which may be measured by a top of the grouser to the base of the grouser 52 at track shoe 40, with a depth gauge. Severe grouser wear may also occur if inappropriate shoe widths are used for the ground 14 the track chain 26 engages with. Additionally, track extensions 431 with excess slack may result in wear of overlapping track shoe surfaces or enlarged bolt holes coupling the track shoe 40 with other components of the track (44, 46). Operation of the work machine on sloped surfaces or maneuvering with sharp turns may further aggravate wear of a side rail of the track link 34. Indentations may occur over long duration of use where the sprocket teeth 33 engages with a pin 36a, bushing 36b or other component on a track chain 26. Other examples of wear identifiable through inspection include worn pin ends. Radial tread wear of the idler wheels 30 may also be impacted by abrasive surface conditions, steep slope operation, and excessive turning. Sprockets 32 will wear on different surfaces depending on forward travel or reverse travel. Methods of acquiring inspection data can include manual inspections, images from cameras or other image type sensors, or thermal sensors to sense heat concentrations after use. The aforementioned inspection data and methods of acquiring inspection data is not restricted to the those described. The historical inspection data 430 may be derived from last known inspection data 437, or alternatively from secondary sources such as an aggregate average inspection data 438 from similar work machines with a similar operation duration or a travelled distance in similar environmental conditions. The predictive maintenance system 400 enables the extraction and identification of features 410 from the historical operational data 405 for an operation parameter 421 most associated with the wear of the tracked undercarriage 20 and train a predictive model 420 using those features 410 to generate or extrapolate a prediction of the maintenance needs or health information of one or more tracked undercarriage components 50 of the tracked undercarriage 20 using non-destructive degradation analysis 450.

Extraction of features 410 from the historical operational data 405 may initiate after a threshold of operation duration 416 or a distance travelled (412, 414), or alternatively identified as a step shift in operating parameters 421. The wear of a tracked undercarriage components 50 is typically non-linear. For example, the first one-third to one-half of the life of a tracked undercarriage component 50 may be minimal.

Depending on environmental and operating conditions, wear may further accelerate if surfaces of a tracked undercarriage component 50 become irregular because of uneven wearing patterns cause from operations as described above. In another example, the threshold of operation duration 416 may refer to a breaking in period of a new track chain 26, before normal use occurs to optimize the longevity of track chain 26. The predictive maintenance system 400 may advantageously identify and account for such changes since the thresholds may differ under various usage and environmental conditions, operation technique, and component choice.

As shown in FIG. 4, secondary source data 460 may include data provided and collected from other secondary users 401, such as other local operators 402. The secondary source data 460 may be used in addition to or as an alternative to the model database 485 when training predictive models 420. In some embodiments, the secondary source data 460 may be included in the output 470 as a visual indicator 471 to an operator interface or display 471. For example, the secondary source data 460 may be displayed as a heat map of local secondary users 401 who have a particular predictions or health information or a remaining useful life expectancy. In some instances, the secondary source data 460 may be processed to create an average (for example, a percentage) of secondary users who are currently performing similar operations or functions (e.g. grading, trenching). Additionally, the secondary source data 460 may further be grouped based on a particular worksite field location, an identification of a secondary user, or other information. In one particular application, the secondary source data 460 may be used to coordinate maintenance schedules for tracked chain components between work machines and machine types to minimize downtime when a work machine is serviced. In other embodiments, the predictive maintenance system 400 may automatically control the work machines 10 with a tracked undercarriage 20. For example, when a prediction or health information 490 includes a recommended time to replace an undercarriage component 50, an order may automatically be placed for the tracked undercarriage component, or the work machine may automatically change its function to reduce load or halt its operation, or redirect itself to a dealer for maintenance. Additionally, an alternate work machine may be directed to substitute while the tracked undercarriage 50 for a work machine 10 is going through maintenance, to reduce worksite downtime.

The one or more processors 87 train a predictive model 420 using the one or more features 410, the historical inspection data 430, and a labeled dataset 480 stored in memory 85 regarding an actual maintenance need or health information 490 of the tracked undercarriage 20. The features 410, labeled datasets 480, also referred herein collectively as training data, may be received from, for example, multiple secondary users 401. In some embodiments, the processors 87 generate the models using machine learning functions. Machine learning functions are generally functions that allow a computer application to learn without being explicitly programmed. In particular, a computer application performing machine learning functions is configured to develop an algorithm based on training data 501. For example, to perform a supervised learning, training a predictive model 420 includes example inputs and corresponding desired outputs, and the processor progressively develops a model that maps input to the outputs 470 included in the training data 420. Machine learning may be performed using various types of methods and mechanism including but not limited to decision tree learning, association rule learning, artificial neural networks, inductive logic programming, support vector machines, clustering, Bayesian networks, reinforcement learning, representation learning, similarity and metric learning, sparse dictionary learning, and generic algorithms.

Accordingly, the processor 87 in this example performs machine learning using the received training data (420, 480) to train and develop a predictive model 420 that outputs a prediction or health information 490 of the tracked undercarriage components 50. In some embodiments, the processor(s) 87 generates different models for different climates, soil compositions, operators, work machine types, operational use, inspection data, tracked undercarriage component design, and the like. For example, a rubber track chain will yield different results from a metal track chain. Additionally, maintenance scheduling suggestions may shift depending on the after-market component type used, and the maintenance habits of the operator. The predictive model(s) 420 generated by the processor(s) 87 may be stored in a model database 485 in memory 85. In some embodiments, the model database 485 is stored and transmitted from a cloud via a communication network, or external server. The model database 485 may be stored on a separate device specific to a worksite, an operator, a work machine, to name a few. Alternatively, or in addition to, the models generated by the processor 87 may be copied to one more separate devices such as databases external to the server.

Accordingly, a processor 87 is configured to generate and apply the one or more predictive models 420 to data using a non-destructive degradation analysis 450 to generate a prediction or health or maintenance need 490 for a tracked undercarriage component 50. The generation of a prediction or health info may be applied to provide a remaining useful life, replacement recommendation, or maintenance needs, or other health information to an operator of an operator interface. This includes the replacement of track chains, lubrication of track chains, sprocket replacement, track shoe replacement, to name a few. In another embodiment, the processor 87 may further recommend a setting or mode to adjust the operating parameters 474 for optimal tracked undercarriage component 50 function given the present conditions, using the predictive models 420 generated. In yet another embodiment, an operator action may be suggested.

In this way, it is possible to achieve the following technical effects: provide real-time product monitoring, enhance preventive maintenance/service cycle and coordination for a worksite through prediction of estimated product life, benchmarking operator control 18 practices in-order to maximize tracked undercarriage component life, mapping theoretical and actual product performance, suggest a track chain 26 for operation specific or region specific needs, and/or provide efficient and accurate root cause analysis.

In the predictive maintenance system, the predictive model 420 is periodically applied via machine learning and updates the prediction and health information 490 using a non-destructive degradation analysis 450, to outputs 470 to one of a plurality of communicatively coupled separate devices. The prediction and health information 400 may also reset a value once a respective tracked undercarriage component 50 is replaced or serviced and outputs 470 a visual indication 471 of the prediction or health information to an operator interface.

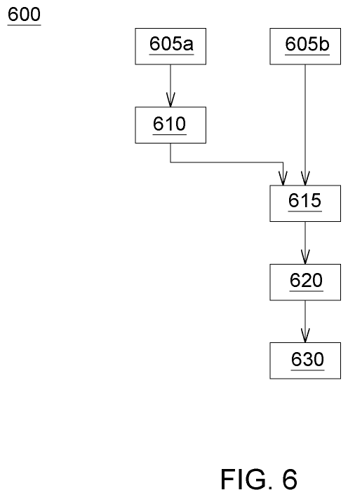

FIG. 6 discloses a method 600 for acquiring a prediction or health information of a tracked undercarriage component 50 from a tracked undercarriage 20 on a work machine 10 using the predictive maintenance system 500 is disclosed. In step 605a, the method comprises a controller 84 of the work machine receiving a historical operational data 405 from sensors associated with the operation of the tracked undercarriage 20. In step 605b, the method comprises receiving a historical inspection data 430 associated with an amount of wear of the tracked undercarriage 20.

In step 610, the method includes extracts one or more features 410 from the historical operational data 405, the one or more features 410 including at least one operation parameter 421 associated with wear of the tracked undercarriage 20:

In step 615, the method 600 includes training a predictive model 420 using the one or more features 410, the historical inspection data 430, and a labeled dataset regarding an actual maintenance need or health information of the tracked undercarriage:

Step 620 discloses applying the predictive model 420 to the one or more features 410 using a non-destructive degradation analysis 450 to generate a prediction of the maintenance needs or health information of one or more components of the tracked undercarriage.

In step 630, the method includes outputting the prediction or health information to an operator interface.

The historical operational data 405 of the method comprises one or more of a forward distance traveled 412 by a track of the tracked undercarriage: a reverse distance traveled 414 by the track of the tracked undercarriage: a duration of operation 416 by the tracked undercarriage; and a rotational torque 418 of the track of the tracked undercarriage. The historical operational data 405 are derived from each of a left track 44 and a right track 46 of the tracked undercarriage 20. The features 410 from the historical operational data 405 comprises a power source utilization duration with a low load condition, a medium load condition, and a high load condition. The historical inspection data 430 comprises one or more of a link height, a bushing wear, a grouser wear, and a track extension.

The historical inspection data 430 is derived from a last known inspection data. The extraction of features 410 from the historical operational data 405 initiate after a threshold of operation duration 416 or a travelled distance. The historical operational data 405 is derived from an aggregate historical operational data 405 from two or more work machines with at least a similar machine type, an operator, a geographic location, a soil type, a dealer, and a work machine operation type. The predictive model 420 is periodically applied, updating the prediction and health information outputs to one of a plurality of communicatively coupled work machines, a central operating center, and a dealer. The features 410 from the historical operational data 405 comprises a power source utilization for a sprocket movement and an implement movement.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

1. A predictive maintenance system utilized in conjunction with a work machine having a tracked undercarriage, the predictive maintenance system comprising:
the tracked undercarriage;
a power source operatively coupled to the tracked undercarriage; and
a controller operatively coupled to the power source, the controller comprising one or more processors and a memory having a predictive maintenance algorithm stored thereon, wherein the processor is operable to execute the predictive maintenance algorithm to:
receive a historical operational data from sensors associated with the operation of the tracked undercarriage;
receive a historical inspection data associated with the amount of wear of the tracked undercarriage;
extract a one or more features from the historical operational data, the one or more features including at least one operation parameter associated with wear of the tracked undercarriage;
train a predictive model using the one or more features, the historical inspection data, and a labeled dataset regarding an actual maintenance need or health information of the tracked undercarriage;
apply the predictive model to the one or more features to generate a prediction of the maintenance needs or health information of one or more components of the tracked undercarriage; and
outputting a visual indication of the prediction or health information to an operator interface.

2. The predictive maintenance system of claim 1, wherein the feature from the historical operational data comprises one or more of:
a forward distance traveled by a track of the tracked undercarriage;
a reverse distance traveled by the track of the tracked undercarriage;
a duration of operation by the tracked undercarriage; and
a rotational torque associated with the track of the tracked undercarriage.

3. The predictive maintenance system of claim 2, wherein the features from the historical operational data are derived from each a left and right track of the tracked undercarriage.

4. The predictive maintenance system of claim 1, wherein the feature from the historical operational data comprises a power source utilization duration with a low load condition, a medium load condition, and a high load condition.

5. The predictive maintenance system of claim 1, wherein the historical inspection data comprises one or more of a link height, a bushing wear, a grouser wear, and a track extension.

6. The predictive maintenance system of claim 1, wherein the historical inspection data is derived from a last known inspection data.

7. The predictive maintenance system of claim 1, wherein extraction of features from the historical operational data initiate after a threshold of operation duration or a travelled distance.

8. The predictive maintenance system of claim 1, wherein the historical operational data is derived from an aggregate historical operational data from two or more work machines with at least a similar machine type, an operator, a geographic location, a soil type, a dealer, and a work machine operation type.

9. The predictive maintenance system of claim 1, wherein the predictive model is periodically applied, updating the prediction and health information outputs to one of a plurality of communicatively coupled work machines, a central operating center, and a dealers.

10. The predictive maintenance system of claim 1, wherein the features from the historical operational data comprises a power source utilization for a sprocket movement and an implement movement.

11. A method for performing a predictive maintenance of a tracked undercarriage on a work machine, comprising:
receiving a historical operational data from sensors associated with the operation of the tracked undercarriage;
receiving a historical inspection data associated with an amount of wear of the tracked undercarriage;
extracting one or more features from the historical operational data, the one or more features including at least one operation parameter associated with wear of the tracked undercarriage;
training a predictive model using the one or more features, the historical inspection data, and a labeled dataset regarding an actual maintenance need or health information of the tracked undercarriage;
applying the predictive model to the one or more features to generate a prediction of the maintenance needs or health information of one or more components of the tracked undercarriage; and
outputting the prediction or health information to an operator interface.

12. The method of claim 11, wherein the feature from the historical operational data comprises one or more of:
a forward distance traveled by a track of the tracked undercarriage;
a reverse distance traveled by the track of the tracked undercarriage;
a duration of operation by the tracked undercarriage; and
a rotational torque of the track of the tracked undercarriage.

13. The method of claim 12, wherein the features from the historical operational data are derived from each of a left track and a right track of the tracked undercarriage.

14. The method of claim 11, wherein the features from the historical operational data comprises a power source utilization duration with a low load condition, a medium load condition, and a high load condition.

15. The method of claim 11, wherein the historical inspection data comprises one or more of a link height, a bushing wear, a grouser wear, and a track extension.

16. The method of claim 11, wherein the historical inspection data is derived from a last known inspection data.

17. The method of claim 11, wherein extraction of features from the historical operational data initiate after a threshold of operation duration or a travelled distance.

18. The method of claim 11, wherein the historical operational data is derived from an aggregate historical operational data from two or more work machines with at least a similar machine type, an operator, a geographic location, a soil type, a dealer, and a work machine operation type.

19. The method of claim 11, wherein the predictive model is periodically applied, updating the prediction and health information outputs to one of a plurality of communicatively coupled work machines, a central operating center, and a dealer.

20. The method of claim 11, wherein the features from the historical operational data comprises a power source utilization for a sprocket movement and an implement movement.
